(19) United States
(12) Patent Application Publication
(10) Pub. No.: US 2014/0116259 A1
(43) Pub. Date: May 1, 2014

(54) INFUSING APPARATUS AND METHODS OF USE

(71) Applicant: Joseph David Landford, Murrieta, CA (US)

(72) Inventor: Joseph David Landford, Murrieta, CA (US)

(21) Appl. No.: 13/965,025

(22) Filed: Aug. 12, 2013

Related U.S. Application Data
(60) Provisional application No. 61/721,205, filed on Nov. 1, 2012.

(51) Int. Cl. A47J 31/44

(52) U.S. Cl. CPC A47J 31/4403
USPC 99/323

(57) ABSTRACT

An apparatus can be used to infuse a substance into a liquid, such as tea or coffee. The apparatus can include a device to raise and/or lower an infuser. The infuser can be held in a raised position generally away from the liquid, or a lowered position generally within the liquid. The apparatus can further include a locking mechanism to secure the infuser in the raised position.

### CROSS-REFERENCE TO RELATED APPLICATIONS

This application claims priority under 35 U.S.C. §119(e) to U.S. Provisional Application No. 61/721,205, filed Nov. 1, 2012, entitled “INFUSING APPARATUS AND METHODS OF USE,” which is hereby incorporated by reference in its entirety. Any and all priority claims identified in the Application Data Sheet, or any correction thereto, are hereby incorporated by reference under 37 CFR 1.57.

### BACKGROUND

1. Field

The present disclosure generally relates to an apparatus for infusing a substance into a liquid.

2. Description of the Related Art

Liquids are commonly infused with an ingredient. For example, tea is prepared by steeping leaves or herbal ingredient in water releasing the favor of leaves or herbal ingredients into the water. Similarly, coffee can be prepared by releasing the flavor of coffee grounds. These ingredients are often removed from the water after a certain amount of time, for example, to prevent the tea or coffee from becoming excessively bitter or too strong.

### SUMMARY

Accordingly, there is a need in the art for improved devices and methods for infusing or steeping an ingredient into a liquid. In some embodiments a device can be used to raise and/or lower an infuser. The infuser can be held in a raised position generally away from the liquid, or a lowered position generally within the liquid. This device and infuser can be integrated into a lid for a container, such that in the raised position the infuser is connected to the lid and in the lowered position the infuser is spaced from the lid.

Certain aspects of this disclosure are directed toward an infusing apparatus including a body portion, a lid portion, a rod, an infuser, and a locking mechanism. The body portion can be configured to contain a fluid. The lid portion can be configured to connect to an upper end of the body portion. The rod can extend axially through the body portion and the lid portion when the lid portion is connected to the body portion. The infuser can connect to the rod and selectively move relative to the rod. The locking mechanism can be configured to prevent the infuser from moving relative to the lid portion, such that the rod is capable of moving independently from the infuser. For instance, the locking mechanism can be a spring lock.

In the above mentioned infusing apparatus, the apparatus can further include an infuser holder coaxially disposed between the infuser and the rod when the infuser is connected to the rod. The infuser holder can be configured to selectively move relative to the rod.

In any of the above mentioned infusing apparatuses, the locking mechanism can include a retainer configured to releasably engage the infuser holder, such that the infuser cannot move relative to the lid portion. The infusing apparatus can further include a release mechanism configured to release the infuser from the lid portion. The release mechanism can include a wedge configured to expand the retainer, such that the retainer releases the infuser holder.

In any of the above mentioned infusing apparatuses, the lid portion can include a number of resilient members configured to engage an upper end of the rod, such that the rod is prevented from moving relative to the lid portion.

In any of the above mentioned infusing apparatuses, the apparatus can include a base portion configured to connect to a lower end of the body portion. The base portion can be configured to contain an ingredient. Further, the base portion can form an airtight seal with the body portion.

Certain aspects of this disclosure are directed toward a method of infusing a liquid. The method can include connecting an infuser to a rod. The rod can be configured to move axially relative to a lid portion. The method can further include connecting the lid portion to a body portion. After connecting the infuser to the rod, the method can include positioning the infuser near a lower portion of the body portion. The method can also include pulling the rod at least partially through the lid portion until the locking mechanism locks the infuser relative to the lid portion. After pulling the rod, the method can include pushing the rod until the lid portion releasably engages an upper end of the rod.

In certain embodiments, an infusing apparatus can include a lid. The lid can include an upper surface having one or more openings, a locking mechanism, a rod, and an infuser. The infuser can be configured to slide on and/or move with the rod. The infuser can be configured to have a first position engaged with the locking mechanism near the lid and a second position spaced from the lid.

According to certain embodiments or aspects, this application is directed toward an infusing apparatus including a top portion. The top portion can include a housing portion having an upper surface having one or more openings, a locking mechanism configured to move between a first position and a second position, and a release mechanism configured to move between a first position and a second position. Moving the release mechanism moves the locking mechanism from a first position to a second position. The infusing apparatus can also include a rod extending through one of the openings and an infuser. The infuser can include an enclosure portion and an infuser channel defining a lumen through which the rod extends. The locking mechanism is configured to engage the infuser in the first position and release the infuser in the second position.

Another aspect of this application is directed toward an infusing apparatus including a top portion. The top portion can include a housing portion, a locking mechanism, and a release mechanism. The infusing apparatus can also include a rod movable along a vertical axis of the housing portion and an infuser configured to move together with or independently of the rod. The locking mechanism is configured to engage the infuser, and the release mechanism is configured to release the infuser from the locking mechanism.

The housing portion of any of the above mentioned aspects of this application can define a first opening. The rod can extend through the first opening.

The rod of any of the above mentioned aspects of this application can include an upper portion and a base portion. A diameter of the base portion can be greater than a diameter of the rod and a diameter of the upper portion can be greater than the diameter of the rod.

The housing portion of any of the above mentioned aspects of this application can define a second opening. The upper surface of the housing portion can also include a third opening. The third opening can larger than the second opening.

The infusing apparatus of any of the above mentioned aspects of this application can also include a threaded portion capable of threadably engaging a corresponding feature of a container when the infusing apparatus is connected to the container.

Yet another aspect of this application is directed toward a method of infusing a liquid. The method can include connecting a top portion to a container containing a liquid, actuating a release mechanism to release an infuser from a locking mechanism of the top portion, infusing the liquid, retracting a rod at least partially through the top portion, engaging the infuser with the locking mechanism, and advancing the rod while the infuser remains stationary. Retracting the rod retracts the infuser.

Actuating the release mechanism can move the locking mechanism between a first position and a second position, and wherein, in the second position, the locking mechanism releases the infuser. In the first position, the locking mechanism is constrained by a channel of the top portion, and, in the second position, the locking mechanism at least partially extends out of the channel of the top portion.

For purposes of summarizing the disclosure, certain aspects, advantages, and features of the inventions have been described herein. It is to be understood that not necessarily any or all such advantages are achieved in accordance with any particular embodiment of the inventions disclosed herein. No aspects of this disclosure are essential or indispensable.

### BRIEF DESCRIPTION OF THE DRAWINGS

Various embodiments are depicted in the accompanying drawings for illustrative purposes, and should in no way be interpreted as limiting the scope of the inventions, in which like reference characters denote corresponding features consistently throughout similar embodiments.

FIG. 1 illustrates a plan view of an infusing apparatus having an infuser in an infusing position.

FIG. 2 illustrates a plan view of the infusing apparatus having the infuser in a non-infusing position.

FIG. 3 illustrates a top view of a top portion of the infusing apparatus.

FIG. 4 illustrates a cross section of the top portion shown in FIG. 3.

FIG. 5 illustrates a schematic view of the infuser.

FIG. 6 illustrates a cross section of the infuser shown in FIG. 5 with the lid in a closed position.

FIG. 7 illustrates a cross section of the infuser shown in FIG. 5 with the lid in an open position.

FIG. 8 illustrates a perspective view of another infusing apparatus.

FIG. 9 illustrates a top view of the infusing apparatus shown in FIG. 8.

FIG. 10 illustrates a bottom view of the infusing apparatus shown in FIG. 8.

FIG. 11 illustrates a partial exploded view of the infusing apparatus shown in FIG. 8.

FIG. 12 illustrates an exploded view of the infusing apparatus shown in FIG. 8.

FIG. 13 illustrates an exploded view of an infuser.

FIG. 14A illustrates a cross-section of the infusing apparatus taken along line 14A-14A of FIG. 9, with the infuser in an infusing position.

FIG. 14B illustrates a cross-section of the infusing apparatus shown in FIG. 14A with the infuser in a retracted position and the rod pulled upward.

FIG. 14C illustrates a cross-section of the infusing apparatus shown in FIG. 14A with the infuser in the retracted position and the rod pushed downward.

FIG. 14D illustrates an enlarged view of the locking mechanism within line 14D-14D of FIG. 14C.

FIG. 14E shows portions of the locking mechanism.

### DETAILED DESCRIPTION

The infusing apparatuses described herein illustrate various examples that may be employed to achieve one or more advantages. These examples are only illustrative and are not intended in any way to restrict the general disclosure presented and the various aspects and features of the disclosure. Not all embodiments will achieve advantages described herein. Furthermore, the phraseology and terminology used herein is for the purpose of description and should not be regarded as limiting.

After infusing a liquid with an ingredient, the ingredient is often removed to prevent the liquid from becoming over-saturated with the ingredient. As such, it can be desirable to have a simple mechanism to remove the ingredient, or a part/majority of the ingredient, from the liquid. It can also be desirable to include a mechanism to steep the ingredient in the liquid a second time if the liquid is not sufficiently saturated with the ingredient, or steep the same ingredient in a second amount of liquid.

In some scenarios, it may desirable to include a simple mechanism to remove the ingredient whether the user is at home or on the go. As such, minimizing the total number of components can be desirable. The mechanism preferably should also be easy to manipulate and/or clean. If the user is on the go, it can also be desirable to include a mechanism to contain the ingredient even after the ingredient has been removed from the liquid in case the user cannot readily dispose of the remaining and/or excess ingredient.

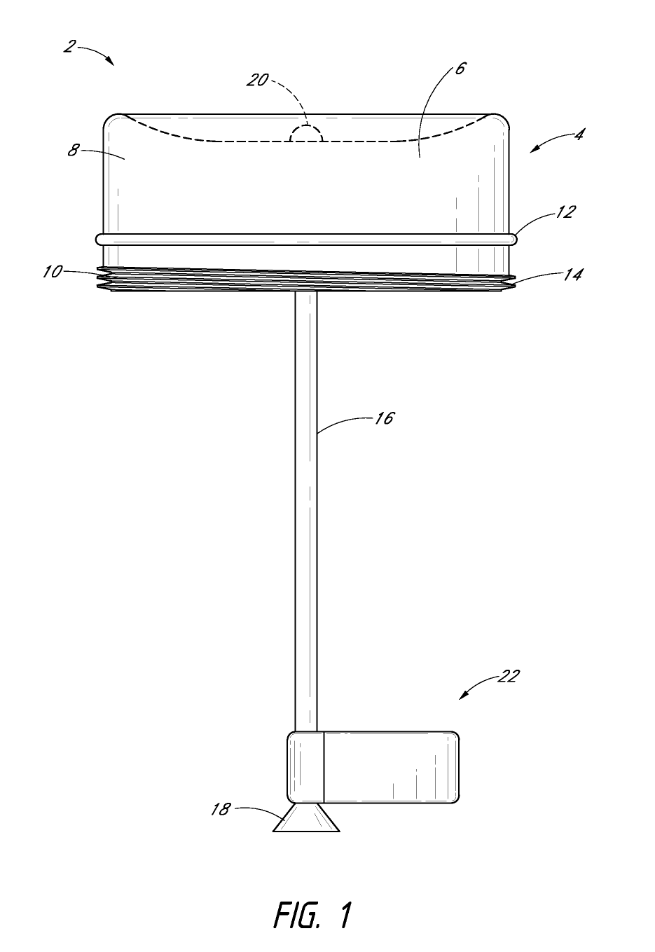

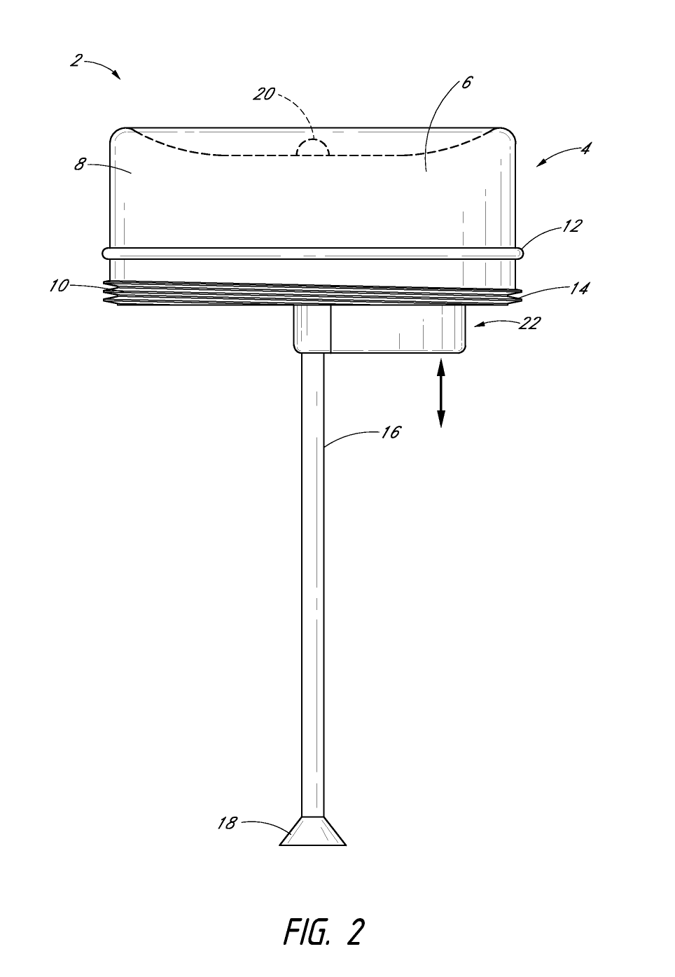

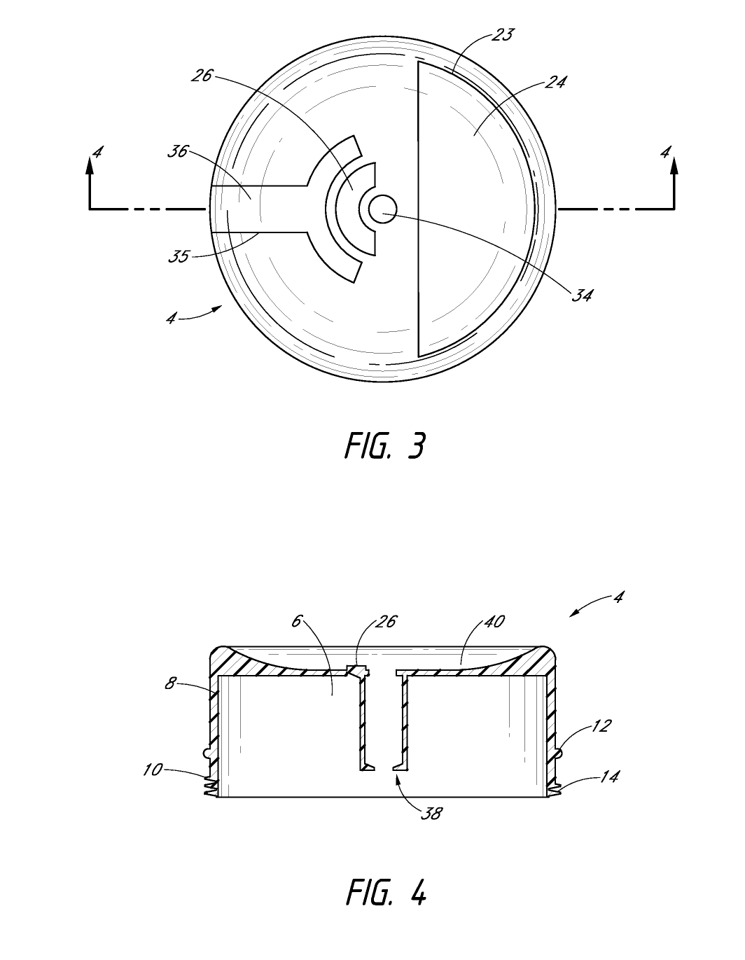

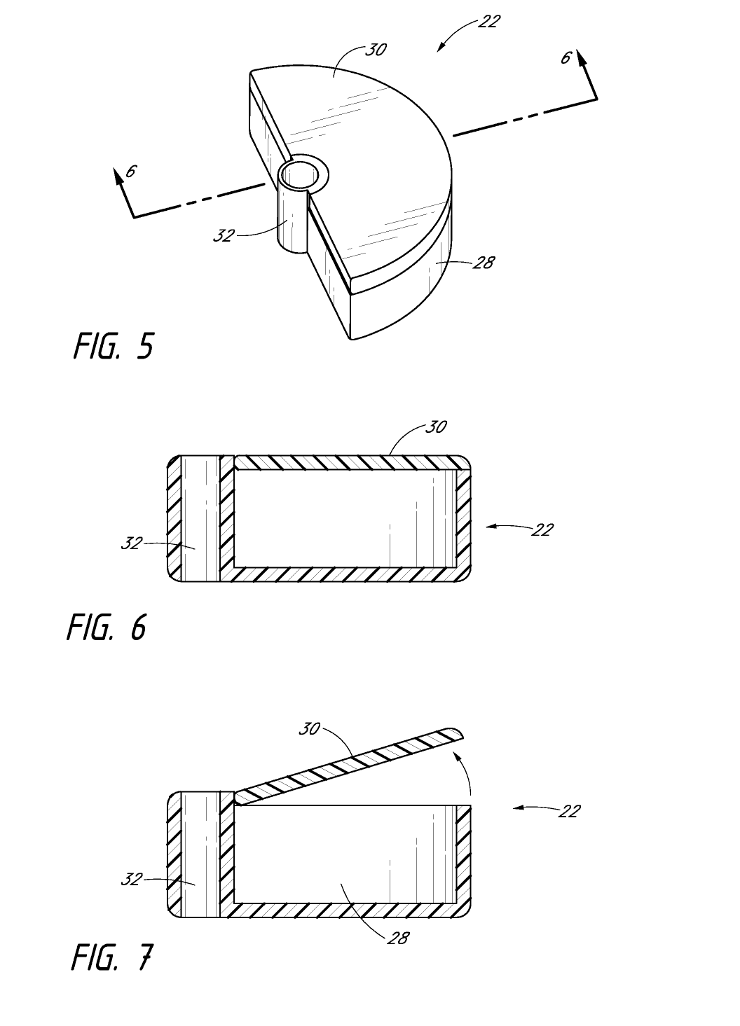

As shown in FIGS. 1 and 2, an infusing apparatus 2 can include a top portion 4 capable of engaging a container. The top portion 4 may also serve as a lid for the container. FIG. 1 illustrates an infuser 22 in an infusing position in which the infuser can infuse a liquid with an ingredient. FIG. 2 illustrates the infuser 22 in a non-infusing position in which the infuser preferably does not infuse the liquid with the ingredient. The top portion 4 can include a housing portion 6, a rod 16 movable along a vertical axis of the top portion 4, and the infuser 22 can be configured to move together with or independently of the rod 16. A locking mechanism 38 (see FIGS. 3-4) can be used to secure the infuser 22 at or near the top portion 4. A release mechanism 26 can be used to release the infuser from the locked position. In some embodiments, the locking mechanism 38 and the release mechanism 26 can be the same system or even the same components.

The top portion 4 is capable of connecting to a container containing a liquid. The top portion 4 can include a housing portion 6 having a substantially cylindrical shape. The top portion 4 can include an upper portion 8 and a lower portion 10. When the infusing apparatus 4 is connected to the container, the upper portion 8 can remain external to the container, while the lower portion 10 extends into the container. The lower portion 10 can include a threaded portion 14, which can connect to a corresponding feature of the container. The housing portion 6 can also include a lip portion 12 that rests on an upper surface of the container.

In another example, the top portion 4 can include the threaded portion 14 along an inner wall of the housing portion 6 and connect to a corresponding feature of the container. In yet another example, the housing portion 6 can snap over a container or snap into a container. Alternately, the top portion 4 can include a mechanism to engage containers of varying sizes. For example, the top portion can include tabs biased to a configuration for engaging a smaller container, but the tabs can be moved outward to engage a larger container.

FIG. 3 illustrates a top view of the top portion 4. The top portion 4 can include one or more openings. For example, the top portion 4 can include a first opening 34 through which the rod 16 extends. As shown in FIG. 3, the first opening 34 is positioned along a central axis of the top portion, though in other embodiments, the first opening 34 can be positioned at any other position of the upper surface of the top portion 4.

The top portion can also include a second opening 35. Liquid can be poured out of the container through the second opening 35. For example, a user can drink liquid from the second opening 35. The second opening 35 can include a lid 36 to seal the second opening 35.

The top portion 4 can also include a third opening 23. The third opening 23 can be larger than the first opening 34 or the second opening 35. The third opening 23 can be used to add liquid and/or other ingredients or substances into the container. The third opening 23 can include a lid 24 to seal the third opening 23.

The upper surface of the housing portion 6 can include a recessed area 40. The recessed area 40 can contain excess liquid that may flow from the container to help minimize potential messes.

Looking at FIGS. 1-3, it can be seen that the rod 16 resides and can move within the first opening 34. This can allow the rod to move the infuser between a lowered position for infusing and a raised or non-infusing position. The rod and infuser can be connected in many different ways. For example, infuser can slide on the rod and the rod can have a base 18 configured to prevent the infuser from passing the base.

The rod 16 can include an upper portion 20 and a base portion 18. In some embodiments, a diameter of the base portion 18 can be greater than a cross-sectional diameter of the rod 16. A diameter of the upper portion 20 can also be greater than a cross-sectional diameter of the rod 16. When the rod 16 is in a distal most position, the upper portion of the rod 20 can be adjacent to the upper surface of the top portion 4. The upper portion 20 and the base portion 18 prevent the rod from inadvertently disconnecting from the top portion 4. In some embodiments, one or more of the upper portion 20 or the base portion 18 can be removed to disconnect the rod from the top portion 4.

A method of infusing can include, after the top portion 4 engages the container, the user can actuate a release mechanism 26 (FIGS. 3-4) to release an infuser 22 from a locking mechanism 38 of the top portion 4. Alternatively, the top portion 4 can engage the container with the infuser 22 already in the infusing position. Releasing the infuser 22 causes the infuser to move along the rod 16 toward the infusing position shown in FIG. 1. The infuser 22 moves along the rod 16 from an upper portion of the rod to a lower portion of the rod. When the infuser 22 is in the infusing position, the infuser can infuse a liquid with an ingredient.

To move the infuser 22 to a non-infusing the position, the rod 16 can be at least partially retracted through the top portion 4. As the base portion 18 of the rod moves upward, the infuser 22 rests on the base portion 18 of the rod and moves upward with the rod 16. When the infuser 22 reaches the top portion 4 a locking mechanism 38 (FIG. 4) can engage the infuser 22. The rod 16 can then be advanced downward independently of the infuser until the upper portion 20 of the rod rests along the upper surface of the top portion 4. After the rod 16 has been advanced, the infuser 22 can remain in the raised non-infusing position as shown in FIG. 2.

As described above, the ability to retract the infuser provides a mechanism to prevent the liquid from becoming over-saturated with the ingredient. This easy to use mechanism can be used whether the user is at home or on the go and can reduce the total number of components necessary to infuse a liquid. If the user is on the go, the infuser can hold the ingredient even after the ingredient has been removed from the liquid in case the ingredient is not readily disposable.

The top portion 4 can also include a locking mechanism 38 as shown in FIG. 4. The locking mechanism 38 can be configured to move between a first position and a second position. In the first position the locking mechanism 38 can engage the infuser 22 and in the second position the locking mechanism 38 can release the infuser 22.

When the infuser 22 is moved to the non-infusing position, the locking mechanism 38 can engage a feature of the infuser 22. Any type of suitable locking mechanism 38 can be used. For example, the locking mechanism 38 can include grasper members capable of engaging the infuser. The graspers can be biased toward a closed configuration. Moving the infuser 22 into the locking mechanism 38 can force the graspers to move outward and engage the infuser 22. The grasping members can include protrusions capable of engaging a recessed portion of the infuser or the grasping members can engage a bottom surface of the infuser.

In another example, the top portion 4 can include a channel. The channel can define a lumen through which the locking mechanism 38 moves. The locking mechanism 38 can be biased toward an open position. In the first position the channel can constrain the locking mechanism 38 and prevent the locking mechanism 38 from releasing the infuser 22. In the second position the locking mechanism 38 can extend at least partially from the channel causing the locking mechanism 38 to not be constrained and release the infuser. The locking mechanism 38 can also be spring-loaded.

The top portion 4 can include a release mechanism 26 to release the infuser 22 from the locking mechanism 38. The user can release the infuser to infuse the liquid if the liquid is not sufficiently saturated with the ingredient or infuse a second amount of liquid with the same ingredient. The user can also release the infuser to clean the infusing apparatus.

The release mechanism 26 can be a button, a twist mechanism, a switch, or any other type of actuation mechanism. The release mechanism 26 is illustrated as a button in FIG. 3. The release mechanism 26 is configured to move between a first position and a second position moving the release mechanism 26 moves the locking mechanism 38 from the first position to the second position. The release mechanism 26 can also be spring-loaded to return to the first position.

The release mechanism 26 can be part of or connected to the locking mechanism 38. For example, the release mechanism 26 can push the locking mechanism 38 out of a channel or beyond a structure constraining the locking mechanism 38 to a constrained position. Alternately, the release mechanism 26 can actuate a hinge feature that causes the locking mechanism 38 to release the infuser. In yet another example, the release mechanism 26 can actuate a separate component that forces the locking mechanism 38 open.

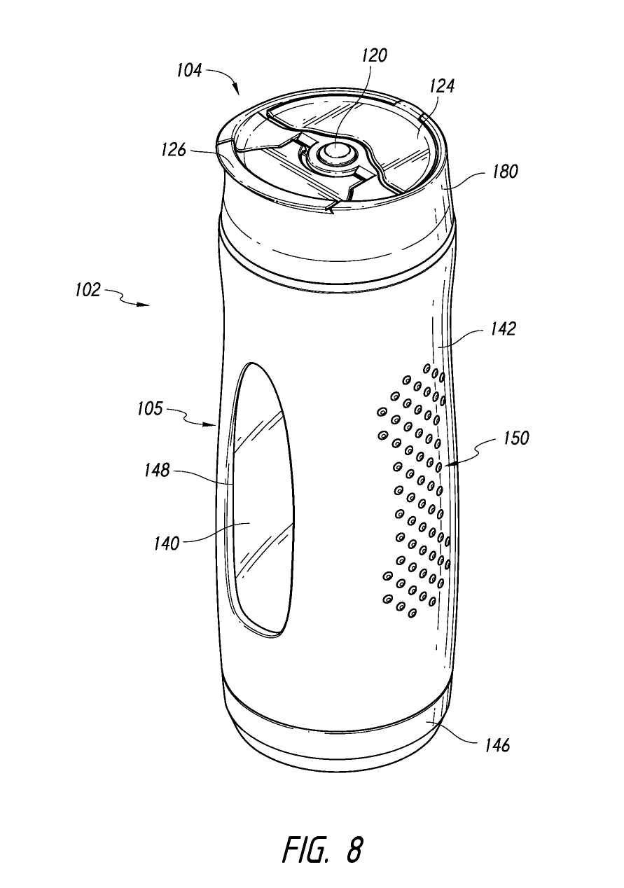

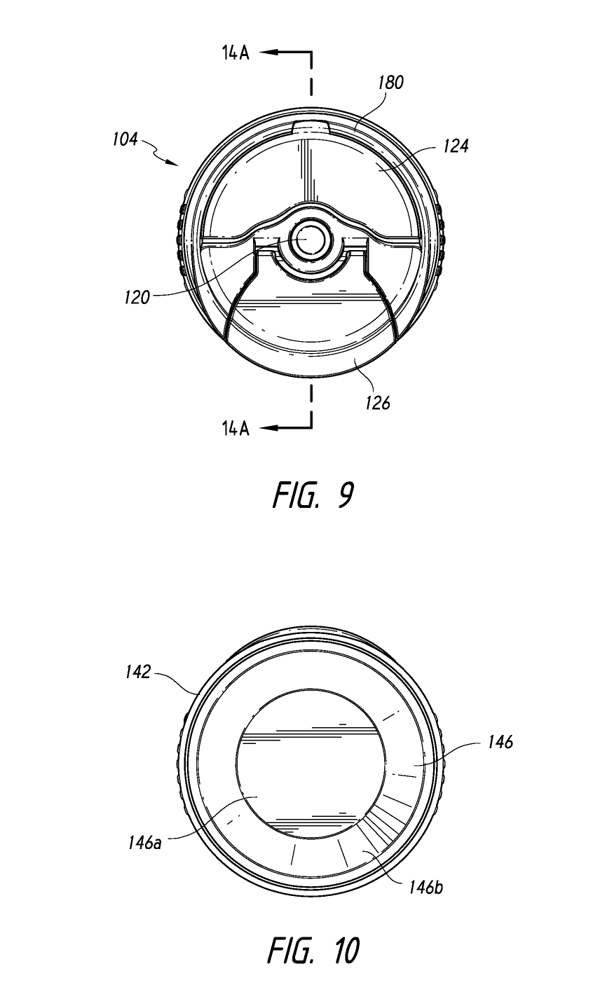

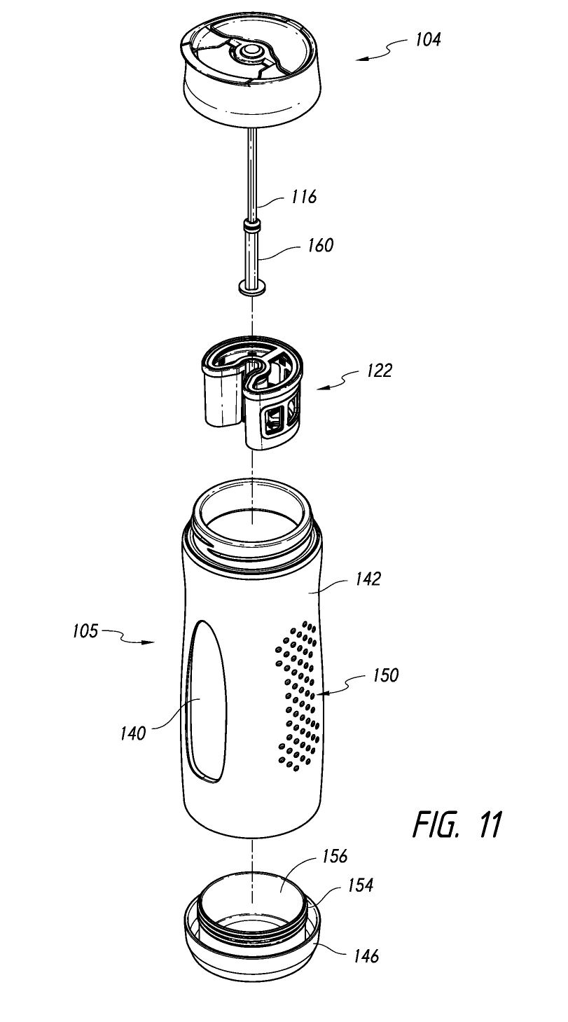

FIGS. 5-7 illustrate different views of an infuser 22. The infuser 22 can include an enclosure portion 28 and a lid portion 30. Although the enclosure portion 28 is illustrated as semi-circular, the enclosure portion 28 can be circular, rectangular, or any other shape. Though not shown, the infuser 22 can include a plurality of holes to infuse a liquid with the ingredient in the enclosure portion 28. A lid 30 can provide access to the enclosure portion 28. FIG. 6 illustrates the lid 30 in a closed position, while FIG. 7 illustrates the lid 30 in an open position.

The infuser 22 can move together with or separately along the rod 16. For example, the infuser 22 can define a channel 32 through which the rod 16 extends. The channel 32 can extend at least partially from the enclosure portion 28, or the enclosure portion 28 can fully encapsulate the channel 32 for an increased enclosure portion volume. Alternatively, the infuser 22 can include a band or other structure defining an opening through which the rod 16 extends.

The infuser 22 can also include a recessed portion. The locking mechanism 38 can engage the recessed portion of the infuser 22. The recessed portion can be positioned along the channel 32, or the recessed portion can be positioned along a wall of the enclosure portion 28. Alternatively, the infuser 22 can include a flange or protruding portion for engaging the locking mechanism 38.

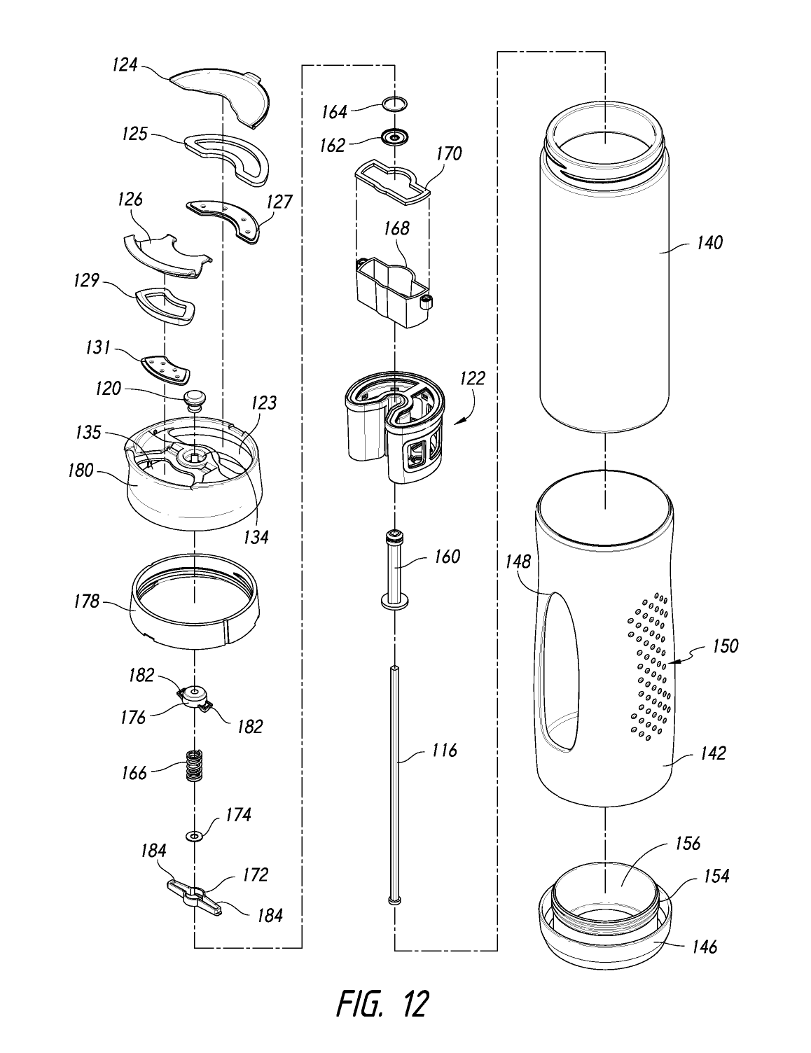

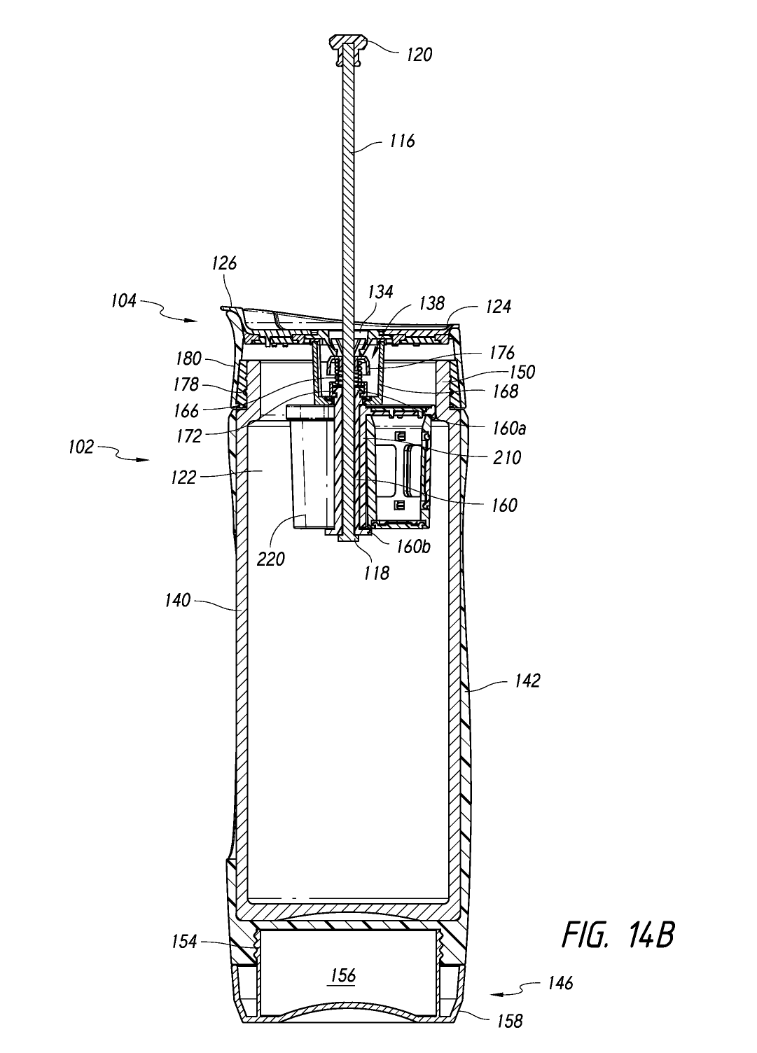

FIGS. 8-14E illustrate another embodiment of an infusing apparatus 102, which can include any of the features of the infusing apparatus 2. As shown in FIG. 8, the infusing apparatus 102 can include a lid portion 104 and a body portion 105. The lid portion 104 releasably engages an upper portion of the body portion 105. In some embodiments, the infusing apparatus 102 can also include a storage compartment 146. The storage compartment may be a base portion 146 of the infusing apparatus. The base portion 146 may releasably engage a lower portion of the body portion 105. The lid and bottom portions can be secured to the body portion using any conventional mechanism, including, but not limited to, a screw fit, a snap fit, a friction fit, a hinge, or a magnet. For example, as will be understood with reference to FIG. 11, the lid portion 104 and the base portion 146 can each threadably engage the body portion 105.

FIG. 11 illustrates a partially exploded view of the infusing apparatus 102, including the lid portion 104, the body portion 105, the base portion 146, and an infuser 122. In some embodiments these components can be disconnected in the manner shown. This can provide many benefits, such as to facilitate washing the infusing apparatus 102. Each of these components will be described in more detail below, starting with the body portion 105.

The body portion 105 can be a container capable of containing a liquid. The body portion can include a threaded portion, which can connect to a corresponding feature of the lid portion. The body portion 105 can be a single piece, or multiple pieces. The body portion can take many forms such as having a single wall or an insulated double wall.

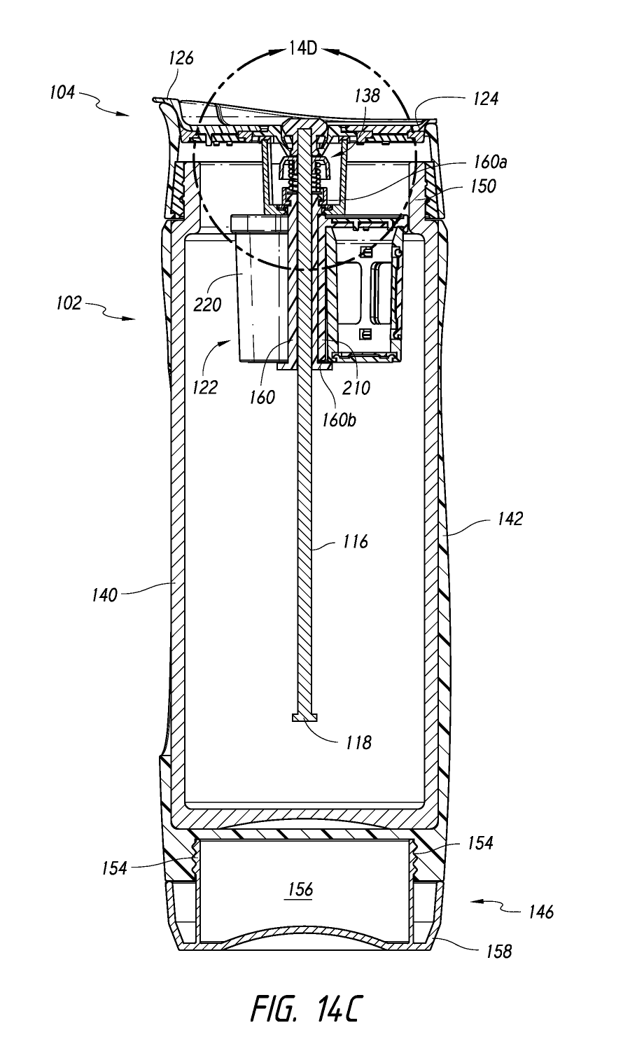

In some embodiments the body portion 105 can include an inner container 140 substantially surrounded by an outer cover 142 as can be seen connected in FIG. 8 and separated in FIG. 12. Generally, the inner container 140 can be substantially cylindrical and can include an open end and a closed end. As discussed above, the lid portion 104 can engage the open end of the inner container 140 to close the open end. In some instances, the inner container 140 can include glass, plastic, and/or metal material. It can be desirable for the inner container 140 to include a material that is at least partially transparent, such that the user can visually identify the level of fluid remaining in the inner container 140.

The outer cover 142 can include a material that is heat resistant, shock absorbent, and/or non-slip. For example, the outer cover can include a silicone material. The silicone outer cover can mitigate the likelihood the user will drop the infusing apparatus 102. In some instances, as shown in FIG. 8, the outer cover 140 can include a grip portion 150 configured to prevent slippage between the infusing apparatus 102 and the user's hand. The grip portion 150 can include a number of protrusions extending from an outer surface of the outer cover 142.

Further, the outer cover 142 can include an opening and/or a window 148. Among other benefits, the window 148 permits the user to examine fluid levels within the inner container 140 when the inner container 140 includes a substantially transparent material. In some embodiments the window can include a substantially transparent material.

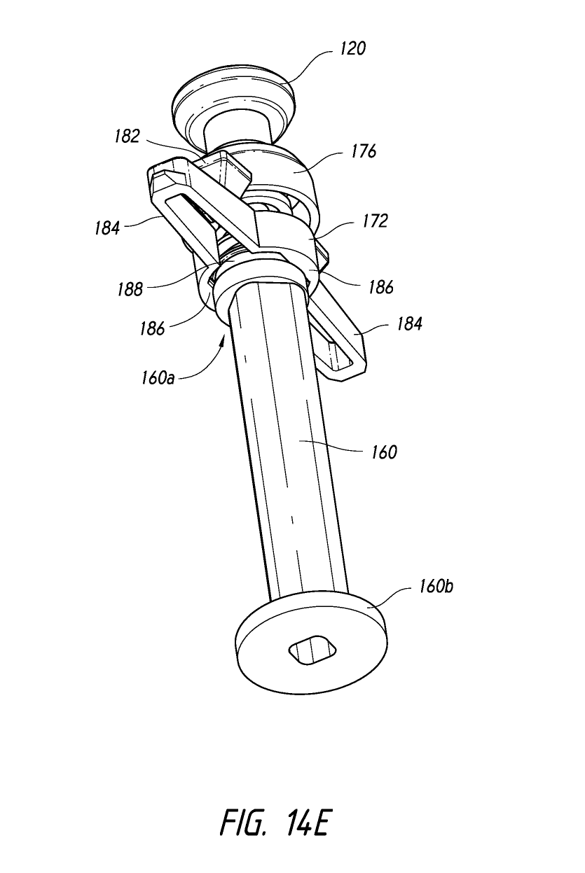

The outer cover 142 can surround the inner container 140 and extend up to a threaded portion of the inner container where the lid portion connects to the inner container. Further, as best shown in FIG. 14A, at least a lower portion of the outer cover 142 can extend beyond a lower end of the inner container 140, such that the outer cover 142 can receive at least a part of the storage compartment or base portion 146. Although, in embodiments without the base portion 146, the lower end of the inner container 140 can be substantially aligned with the lower end of the outer cover 142.

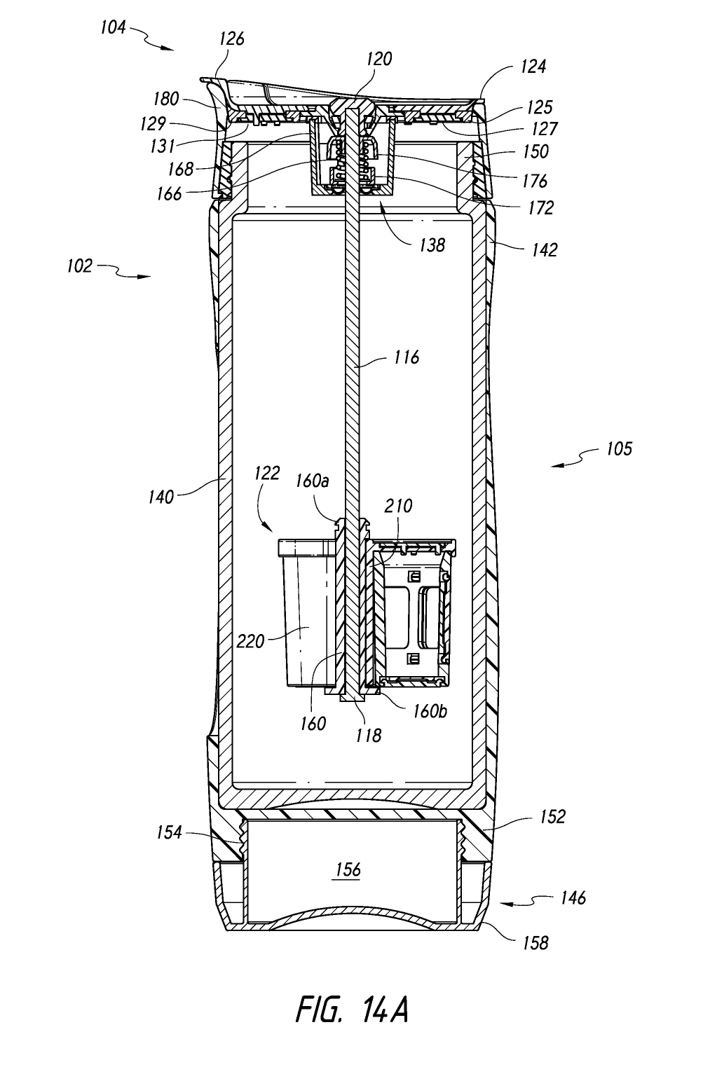

Turning to FIG. 10, a bottom view of the base portion 146 is illustrated. The base portion 146 can be part of the body portion or a separate piece. The illustrated base portion is substantially circular, although other shapes are possible. For example, the bottom portion may have a shape similar to the shape of the body portion 104. Further, as shown in FIG. 10, a central portion 146a of the base portion 146 can be recessed from a remaining portion 146b of the base portion 146.

In some instances, the base portion 146 can be a storage compartment or container, for example, the base portion 146 can define a cavity 156 (FIG. 11) for storing an ingredient, such as coffee grounds or tealeaves.

The bottom portion 146 can include an interior portion surrounded by an exterior portion 158. In some instances, the interior portion can include a number of seal rings or the entire interior portion can be a seal ring to create an airtight connection between the bottom portion 146 and the outer cover 142, thereby protecting the stored ingredient from exposure to the environment. In addition, the bottom portion 146 can include threads 154 and be threadably received into the body portion 105, such as into the outer cover 142. Further, at least a portion of the base portion 146 (e.g., interior and/or exterior portions) can include a shock absorbent material, such as polyurethane or silicone, to help protect the inner container 140 from damage.

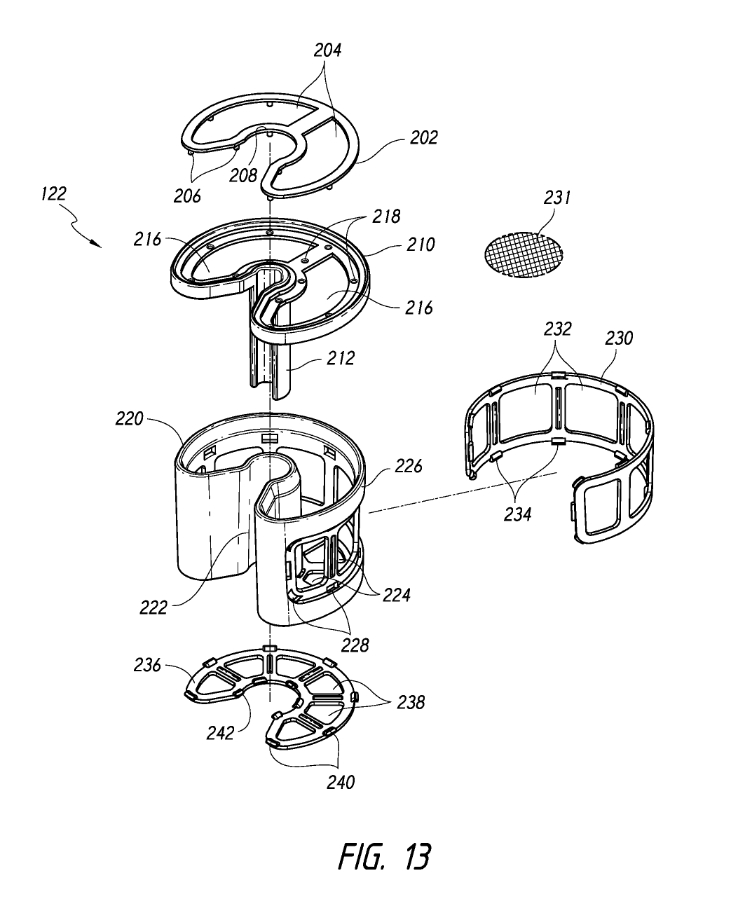

As has been discussed, the lid portion 104 can releasably engage to an upper portion of the body portion 105. The lid portion 104 can serve as a lid for the infusing apparatus and can be used to prevent or allow access to the internal cavity of the infusing apparatus. As shown in FIGS. 8-9, a top surface of the lid portion 104 can include one or more lids 124, 126. The one or more lids can cover one or more corresponding openings. The openings can be used for many purposes, for example, liquid can be poured out of the container through an opening, a user can drink liquid from an opening, liquid and/or other ingredients or substances can be added into the infusing apparatus through an opening.

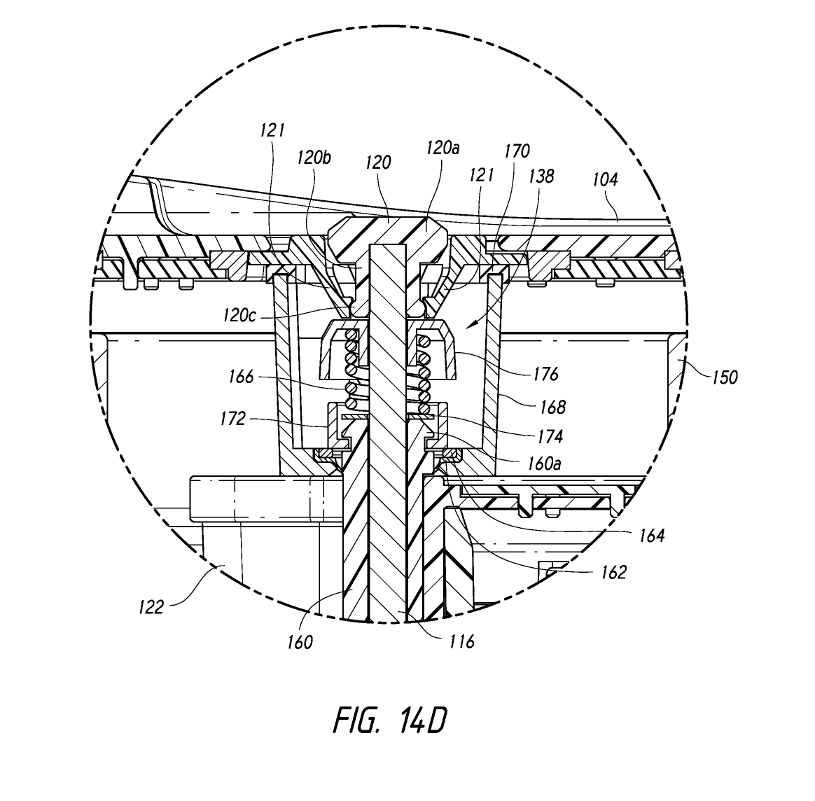

Each of the lids 124, 126 can pivot relative to the outer lid portion 180. FIG. 13 illustrates an exploded view of the infusing apparatus 102 including the components of the lid portion. As will be understood in reviewing FIGS. 9 and 13, the lid 124 can close an opening 123 and the lid 126 can close an opening 135. The opening 123 can be large enough for water to be poured into the opening 123 or to otherwise provide access inside the infusing apparatus 102. The lid 126 can close an opening 135 that is large enough for a user to drink fluid from the opening 135.

As illustrated, the lid 124/opening 123 can be larger than the lid 126/opening 135. In some instances, the opening 123/lid 124 can occupy approximately half of an upper surface of the lid portion 104. In some instances, the opening 135/lid 126 can occupy approximately one-third of the upper surface of the lid portion 104. Although, in other examples, the openings or lids can be different in number, size, shape, or position, depending on the desired functionality and design aspects of the infusing apparatus 102. In some examples, the lid portion 104 may include only one opening for both drinking and pouring.

As shown in FIG. 13, each of the lids 124 and 126 can include a number of similarly shaped components 129, 131, 125, 127 configured to provide a watertight seal between the infusing container and the external environment. One or more of these components can include plastic, silicone, or other similar materials. For example, the lid 124 has a base component 127 and a sealing component 125. The sealing component 125 can be received between the lid 127 and the base component 127.

Further, as shown, the lid portion 104 can include an outer lid portion 180 and an inner lid portion 178 that fits within the outer lid portion 180. The outer lid portion can include the openings 123, 134, 135 described above. The inner lid portion 178 can include a threaded portion for engaging the threaded portion of the inner body 140. It will be understood that in some embodiments a threaded portion can be integrally formed with the outer lid portion 180.

As discussed in previous embodiments, the lid portion 104 can also include an opening 134 to receive a rod 116 (see FIGS. 11-12). In addition, the lid portion 104 can also include a release mechanism 120 and/or a locking mechanism 120. As is discussed in more detail below, the rod 116 can reside and move within the opening 134. This can allow the rod to move an infuser 122 between a lowered position for infusing and a raised or non-infusing position.

As shown in the figures, the infusing apparatus 102 can further include an infuser 122 configured to contain an ingredient for infusing into a liquid within the body portion 105. The infuser 122 can include an infusing container 220 that should be constructed to permit fluid to flow into the infusing container 220. For example, the entire infusing container 220 can be constructed from a filter material, such as a fine mesh. As another example, as shown in FIG. 13, the infusing container 220 can include a number of side openings 224 through which fluid can pass through to absorb the flavor of the ingredient. It will be understood that the infusing container 220 will include openings on at least one of the top, bottom, and side. These openings can take many different shapes and sizes depending on the desired use. In a preferred embodiment, a metal or plastic mesh material 231 covers a substantial amount of the surface area of the infusing container 220 to permit the free flow of fluid into and out of the infusing container 220.

In the illustrated embodiment of FIG. 13, the infuser 122 includes an infusing container 220 with a side filter portion 230, and base portion 236 that can be snapped into the infusing container 220. A filter or mesh material 231 can be placed between the infusing container 220 and one or more of the side filter portion 230 and the base portion 236. In addition, a cap portion 210 can also have a filter material 231 disposed between it and a filter holder 204. The cap portion 210 can function as a lid to the infusing container 220. Thus, the cap portion 210 can be easily removed from the infusing container 220 to allow ingredients to be placed therein and attached or closed to prevent large portions of the ingredients from leaving. Of course, at least a portion of the ingredients is desirably absorbed by the fluid and taken from the infuser.

The side filter portion 230 can be generally rounded to fit along the rounded, front surface 226 of the infusing container 220. The side filter portion 230 can include a number of openings 232 through which fluid can pass through. Further, the side filter portion 230 can include a number of features 232 (protrusions, nubs, or likewise) configured to engage a corresponding feature 223 of the infusing container 220 (e.g., grooves, indentations, or likewise) to capture the mesh material between the infusing container 220 and the side filter portion 230.

The bottom filter portion 236 can be secured to the bottom of the infusing container 220. For example, the bottom filter portion 236 can include a number of features 240 (protrusions, nubs, or likewise) for connecting to a number of corresponding features (not shown) on the bottom portion of the infusing container 220. The bottom filter portion 236 can include a number of openings 238 through which fluid can pass to absorb flavor from the ingredient.

The infusing container 220 can also include a lid or cap portion 210. The cap portion 210 can be secured to a top surface of the infusing container 220. For example, the cap portion 210 and the infusing container 220 can form a snap fit. A top surface of the cap portion 210 can include a number of openings 216 through which fluid can pass through into the infusing container 220.

A filter material can be disposed between the cap portion 210 and a filter holder 204. The filter holder 202 can include a number of openings 204 through which fluid can pass into the infusing container 220. Further, the filter holder 202 can include a number of features 206 (protrusions, nubs, or likewise) configured to connect to corresponding features 218 of the cap portion 210 (e.g., grooves, indentations, or likewise).

In another example, the side filter portion 230, the cap portion 210, the base portion 236, or any combination thereof can be constructed from a mesh material. In yet another example, a mesh material can be positioned within each of the openings of the side filter portion 230, the cap portion 210, and/or the base portion 236. Each of the side filter portion 230, the cap portion 210, and/or the base portion 236 can be constructed from a plastic or metal (e.g., stainless steel) material.

The infuser 122 can be constructed from a polymer (e.g., polyurethane) and/or a metal material (e.g., stainless steel). Further, the infuser 122 can be shaped and sized for axial movement within the body portion 105, such as within the inner container 140. For example, the infusing container 220 can be substantially C-shaped and include at least a rounded, front surface 226, although other shapes are possible depending on the shape of the body portion 105 and desired size of the infuser 122.

The infusing container 220 can also include a rear surface 222 at least partially defining a channel shaped to directly or indirectly engage the rod 116 and/or a rod-shaped infuser holder 160 (FIG. 12), such that the infusing container 220 can move axially along the rod 116.

Further, the cap portion 210 can include an axially extending connector 212. The connector 212 can engage the infuser holder 160 such that the connector 212 is coaxially disposed between the infuser holder 160 and the infusing container 220. The filter holder 202 on the cap portion 210 can also include a rear surface 208 shaped to engage the rod 116 or the infuser holder 160.

In examples having the infuser holder 160, the infuser holder 160 can be coaxially disposed between the rod 116 and the infusing container 220. The infusing container 220 can attach directly or indirectly onto the rod 116 and/or infuser holder 160. For example, the infusing container 220 can be capable of bending to clip directly or indirectly onto the rod 116 and/or infuser holder 160. As shown in FIG. 13, the infusing apparatus 220 can clip onto a semi-tube connector 212 of a cap portion 210, which clips onto the infuser holder 160.

The infusing apparatus 102 can include an infuser holder 160 configured to selectively slide along the rod 116 while carrying the infuser 122 as can be seen in FIGS. 14A-D. The infuser holder 160 can define a lumen through which the rod 116 extends axially. Further, the infuser holder 160 can include an upper portion 160a and a bottom portion 160b each having a diameter that is larger than a central portion of the infuser holder 160. Further, the diameters of the upper and lower portions 160a,b are sufficiently large to prevent the infuser 122 from moving axially relative to the infuser holder 160 when the infuser 122 is connected to the infuser holder 160. It will be understood that the infuser and infuser holder can connect in other ways as well.

As shown, a rod 116 can extend axially through the infusing container 102. The rod 116 can include a base portion 118 having a diameter that is larger than a remaining portion of the rod 116 and larger than a lumen defined by the infuser holder 160. The base portion 118 is sized such that the infuser 122 and/or infuser holder 160 is prevented from moving downward off of the rod 116. A knob 120 connects to a top portion of the rod 116. The knob 120 can prevent the rod from falling out of the lid portion 104. Thus, the knob can be larger than a diameter of the rod, such that the rod can easily advance within a hole 134 in the lid portion. The knob 120 and base portion 118 can prevent the rod from separating from the lid portion 104, though, in some embodiments, the rod can be detachable from the lid portion.

In use, an ingredient can be put into the infuser 122 before the infuser 122 is connected directly or indirectly to the rod 116 (see FIG. 11). Thereafter, the lid portion 104 can be connected to the body portion 105. In some methods, the body portion 105 is already filled with a fluid when the lid portion 104 is connected to the body portion 105. In other methods, the lid portion 104 is first connected to the body portion 105 and then fluid is poured through the opening 123 and over the infuser 122.

Once assembled, the infuser 122 can be positioned near the bottom of the inner container 140. FIG. 14A illustrates the infusing apparatus 102 with the infuser 122 positioned along a bottom portion of the rod 116 in an infusing position. In this infusing position, the fluid can absorb the flavor of the ingredients within the infuser 122.

After a period of time, the infuser 122 can be pulled upward and locked into place as shown in FIG. 14B. The knob 120 can be gripped to then pull the rod 116 and thereby the infuser 122 upward until the infuser 122 engages a locking mechanism 138. As described in more detail below, the locking mechanism can be a spring lock 138 that engages an upper portion 160a of the infuser holder 160. Once the infuser holder 160 (or infuser 122) has been engaged, the rod 116 can move independently of the infuser 122 and can be pushed downward until the knob 120 is positioned as shown in FIG. 14C. The knob 120 can be configured to releasably lock into the lid portion 104.

The lid portion 104 can include a locking mechanism 138. FIGS. 14D-E illustrate an enlarged view of the locking mechanism 138. The individual components of the locking mechanism can also be seen in the exploded view of FIG. 12. The locking mechanism 138 can be positioned within a housing 168. The housing 168 can be attached to the lid portion 104. A sealing member or gasket 170 can be used to provide a fluid seal at the connection between the housing 168 and the lid portion 104. A seal can also be provided at the bottom of the housing to seal or substantially seal the interface between the rod 116 and the housing. For example a gasket 162 can be held in place in the bottom of the housing with a metal or hard plastic press ring 164. The gasket can be flexible enough to seal against the rod while allowing a structure larger than the rod to pass therethrough to lock with the locking mechanism. For example, the upper portion 160a of the infuser holder 160 is shown being larger than the diameter of the rod, the gasket 162 can seal against both the rod and the infuser holder. Another feature of the locking mechanism can include a washer 174 can also be positioned between the spring 166 and the bottom of the housing to help ensure that the spring does not extend past or outside of the housing.

The locking mechanism 138 can be a spring lock. The spring lock can include a spring 166 positioned between a retainer 172 and a release mechanism 176. The retainer 172 can be configured to engage an upper portion 160a of the infuser holder 160 or another portion of the infuser 122 to hold the infuser in a raised position as has been described. The release member 176 can be pressed downward onto the retainer to force the retainer 172 to release the infuser and allow it to move down the rod 116 to a lowered position. Pressing downward on the release member 176 also compresses the spring 166 which allows the release member 176 to move towards the retainer 172.

The knob 120 can be used as a release button 120 to push downward on the release mechanism 176. In the illustrated embodiment, the release mechanism includes one or more wedges 182. The wedges 182 can expand the retainer 172 to release the infuser holder 160 to permit the infuser 122 to move axially along the rod 116. As can be seen in FIG. 14E, the retainer 172 has a pair of arms 184 with open cavities passing therethrough configured to receive the wedges 182. The retainer 172 can also include one or more ledges 186 configured to engage a portion 188 of the infuser 122 or the infuser holder 160. For example, the ledges 186 can engage a stem below a head, or a smaller diameter section of a shaft. In the illustrated embodiment, the upper portion 160a of the infuser holder has a tapered tip with a smaller diameter section adjacent the tapered tip to be received into the retainer by two ledges 186. The smaller diameter section is positioned between two larger diameter sections to effectively limit the location of engagement with the retainer 172.

The lid portion 104 can also include a release knob 120 configured to release the infuser 122 from the locking mechanism 138. The release knob 120 can be centrally located, although other positions are possible. Further, the release knob 120 can be releasably locked into the lid portion 104. As shown in FIG. 14D, the release knob 120 can include an upper portion 120a, a mid-portion 120b, and a lower portion 120c. The upper portion 120a can include a diameter that is larger than the diameter of the opening 134, such that the upper portion 120a cannot be pushed through the opening 134. The mid-portion 120b can include a diameter that is smaller than the diameter of the upper portion 120a. The diameter of the mid-portion 120b should be sufficiently small to extend through the opening 134. The lower portion 120c can include a diameter that is greater than the diameter of the mid-portion 120b, but less than the diameter of the upper portion 120a.

The lid portion 104 can include a number of resilient members 121 extending downward from an upper surface of the lid portion 104 and spaced apart from each other around the opening 134. Each resilient member 121 can include an abutment surface at a bottom end of the resilient member 121 to abut a bottom portion of the knob 120. Further, each resilient member 121 can extend inward, such that the resilient members 121 define an opening having a smaller diameter than the diameter of the opening 134. The opening defined by the resilient members 121 can be large enough for the rod 116 to move axially, but sufficiently small for the resilient members 121 to engage the lower portion 120c of the knob 120. The resilient members 121 can be biased inward to lock the lower portion 120c of the knob 120 in place, such that the rod 116 cannot move out of the infusing apparatus 102. When the knob 120 is pushed further inward or downward, the knob presses on the release member 176 and compresses the spring. This causes the infuser to be disengaged if locked with the locking mechanism. In addition, when the knob is released from being pressed the compressed spring expands. The spring force can be large enough to overcome the resistance of the resilient members 121 from holding the knob down and releases the knob 120. The knob 120 can pop-up when pressed down past the resilient members 121, but locks in place when only pressed into contact with the resilient members 121.

When the user is ready to wash the infusing apparatus 102, the infuser 122 can be disconnected from the rod 116, and the base portion can be disconnected from the body portion 150, as shown in FIG. 11.

Certain aspects of this disclosure are directed toward a method of infusing a liquid. The method can include connecting an infuser to a rod. The rod can be configured to move axially relative to a lid portion. The method can further include connecting the lid portion to a body portion. After connecting the infuser to the rod, the method can include positioning the infuser near a lower portion of the body portion. The method can also include pulling the rod at least partially through the lid portion until the locking mechanism locks the infuser relative to the lid portion. After pulling the rod, the method can include pushing the rod until the lid portion releasably engages an upper end of the rod.

In the above mentioned method, the method can include releasing the rod from the lid portion, thereby releasing the infuser from the lid portion.

In any of the above mentioned methods, connecting the infuser to the rod can include connecting the infuser to an infuser holder connected to the rod. The locking mechanism can be configured to releasably engage the infuser holder.

In any of the above mentioned methods, the method can include connecting a base portion to the body portion. The base portion can be configured to store an ingredient. The base portion can also be configured to form an airtight seal with the body portion.

For expository purposes, Terms such as “above,” “below,” “bottom,” “top,” “side,” “higher,” “lower,” “upper,” “downward,” “upward,” “over,” and “under,” are defined with respect to a horizontal plane. The horizontal plane is defined as a plane parallel to the plane or surface of the floor of the area in which the device being described is used or the method being described is performed, regardless of its orientation.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Some embodiments have been described in connection with the accompanying drawings. However, it should be understood that the figures are not drawn to scale. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, it will be recognized that any methods described herein may be practiced using any device suitable for performing the recited steps.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above, but should be determined only by a fair reading of the claims that follow.

Similarly, this method of disclosure, is not to be interpreted as reflecting an intention that any claim require more features than are expressly recited in that claim. Rather, as the following claims reflect, inventive aspects lie in a combination of fewer than all features of any single foregoing disclosed embodiment. Thus, the claims following the Detailed Description are hereby expressly incorporated into this Detailed Description, with each claim standing on its own as a separate embodiment.

What is claimed is:

1. An infusing apparatus comprising:
a body portion configured to contain a fluid;
a lid portion configured to connect to an upper end of the body portion;
a rod extending axially through the body portion and the lid portion when the lid portion is connected to the body portion;
an infuser comprising a container having a lid, the container configured to hold an ingredient, the infuser connected to the rod and configured to selectively move relative to the rod; and
a locking mechanism configured to prevent the infuser from moving relative to the lid portion, such that the rod is capable of moving independently from the infuser.

2. The infusing apparatus of claim 1, further comprising an infuser holder coaxially disposed between the infuser and the rod when the infuser is connected to the rod, the infuser holder configured to selectively move relative to the rod.

3. The infusing apparatus of claim 2, wherein the locking mechanism further comprises a retainer, the retainer configured to releasably engage the infuser holder, such that the infuser cannot move relative to the lid portion when the infuser holder is engaged by the retainer.

4. The infusing apparatus of claim 3, further comprising a release mechanism configured to release the infuser from the lid portion, the release mechanism comprising a wedge configured to expand the retainer, such that the retainer releases the infuser holder.

5. The infusing apparatus of claim 1, wherein the lid portion comprises a number of resilient members configured to engage an upper end of the rod, such that the rod is prevented from moving relative to the lid portion.

6. The infusing apparatus of claim 1, wherein the locking mechanism is a spring-loaded locking mechanism.

7. The infusing apparatus of claim 1, further comprising a base portion configured to connect to a lower end of the body portion, the base portion configured to contain an ingredient.

8. The infusing apparatus of claim 7, wherein the base portion forms an airtight seal with the body portion.

9. An infusing apparatus comprising:
a body portion configured to contain a fluid;
a lid portion configured to connect to an upper end of the body portion, the lid portion having at least one opening;
a rod extending axially through the body portion and the lid portion when the lid portion is connected to the body portion, the lid portion configured to selectively engage an upper end of the rod;
an infuser comprising a container having a lid, the container configured to hold an ingredient, the infuser connected to an infuser holder coaxially disposed between the infuser and the rod, the infuser holder configured to selectively move relative to the rod; and
a spring-based locking mechanism comprising a retainer configured to releasably engage the infuser holder, such that the infuser cannot move relative to the lid portion when the infuser holder is engaged by the retainer.
